(19) United States
(12) Patent Application Publication
(10) Pub. No.: US 2018/0239603 A1
(43) Pub. Date: Aug. 23, 2018

(54) Software Development Estimating Based on Functional Areas

(71) Applicant: International Business Machines Corporation, Armonk, NY (US)

(72) Inventors: Luca Balestrazzi, Rome (IT); Fabio De Angelis, Rome (IT); Andrea Napoleoni, Rome (IT); Stefano Sidoti, Rome (IT)

(21) Appl. No.: 15/440,714

(22) Filed: Feb. 23, 2017

(51) Int. Cl. G06F 9/44

(52) U.S. Cl. CPC G06F 8/77; G06F 8/10

(57) ABSTRACT

A mechanism is provided for managing a development of a software program. An indication of one or more development tasks of the software program being completed is received. One or more development parameters of each of the one or more software artifacts is retrieved and each of the one or more software artifacts is associated with one or more functional areas of the software program. One or more development parameters of each of the one or more functional areas is calculated. A functional specification of the software program to be developed is retrieved and the functional specification is associated with one or more selected functional areas of the one or more functional areas. One or more development parameters of the functional specification are estimated. An indication of the one or more development parameters of the functional specification for managing a development thereof is then output.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

The present disclosure relates to the information technology field. More specifically, this disclosure relates to software development.

Software development is a very complex activity, especially when it relates to the development of large software programs (for example, running in heterogeneous network environments or with multi-tier structures). Indeed, the development of any software program generally comprises an analysis phase for collecting its functional requirements, a design phase for defining its architecture, an implementation phase for implementing its code and a test phase for verifying its operation (with the software program that is then deployed into production once an acceptable level of quality has been obtained); moreover, during its life cycle the software program is further subject to maintenance operations (for correcting defects, adding functionalities, releasing new versions).

Some tools are available to facilitate the software development. For example, Integrated Development Environments (IDEs) provide a single comprehensive environment that integrates several utilities (with similar user interfaces)) relating to the different tasks of the software development. Particularly, any IDE generally comprises a modeling tool for the analysis phase. The modeling tool allows simplifying the representation of different features of any software program by means of a model thereof (for example, based on user stories or use cases), which model provides an abstraction of (real) artifacts of the software programs to be implemented (for example, files); in this way, it is possible to visualize, assess and communicate the software programs to corresponding stakeholders before their actual implementation.

In this context, a technique has been proposed for determining if use cases or user stories are complete given a set of requirements, determining if there are too many use cases or user stories and bridging use cases and user stories from requirements to software implementation and test.

A technique has been proposed for building use cases and related state diagrams based on a model of business activities (with a graphical user interface, which illustrates the relationship among use cases and the relationship between use cases and business requirements, and a state diagram component operable to prepare state activity diagrams based on the business activities).

A technique has been proposed for sequentially displaying the process of generating a test case from a use case diagram and automating the test case generation process, by using a use case specification in which a procedure or method scenario of a function is specified in a use diagram, to thus allow a layman to easily generate a certain level of a test case.

A technique has been proposed for structuring the use cases of a software application (using the units of functionalities being identified))), using the structured use cases to generate use case activity diagrams from them, and generating test cases from these use case activity diagrams.

A technique has been proposed for deriving test cases for workflow based system requirements based on use case descriptions. The use cases are comprised of activity diagrams that comprise multiple activity steps/elements (the activity diagrams being structured as a flowchart or flow diagram); intended test scenarios are derived by traversing various paths through these activity diagrams, with a test case scenario that is created corresponding to a use case scenario by matching each use case activity with an appertaining test.

However, the management of the software development remains quite challenging. Particularly, a planning of its tasks is still a manual operation, which then strongly depends on personal skills, it is prone to errors and it is scarcely repeatable.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for managing a development of a software program. The illustrative embodiment receives an indication of one or more development tasks of the software program being completed, each of the one or more development tasks relating to one or more software artifacts of the software program. The illustrative embodiment retrieves one or more development parameters of each of the one or more software artifacts. The illustrative embodiment associates each of the one or more software artifacts with one or more functional areas of the software program. The illustrative embodiment calculates one or more development parameters of each of the one or more functional areas according to the one or more development parameters of the software artifacts associated with the functional area. The illustrative embodiment receives a functional specification of the software program to be developed. The illustrative embodiment associates the functional specification with one or more selected functional areas of the one or more functional areas according to a comparison of the functional specification with corresponding identification information of the one or more functional areas. The illustrative embodiment estimates one or more development parameters of the functional specification according to the one or more development parameters of the one or more selected functional areas. The illustrative embodiment outputs an indication of the one or more development parameters of the functional specification for managing a development thereof.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes—such as value, content and representation). Particularly:

FIG. 1A-FIG. 1D show the general principles of the solution according to an embodiment of the present disclosure;

FIG. 2 shows a schematic block diagram of a computing system Wherein the solution according to an embodiment of the present disclosure may be practiced;

FIG. 3 shows the main software components that may be used to implement the solution according to an embodiment of the present disclosure; and

FIG. 4A-FIG. 4B show an activity diagram describing the flow of activities relating to an implementation of the solution according to an embodiment of the present disclosure.

### DETAILED DESCRIPTION

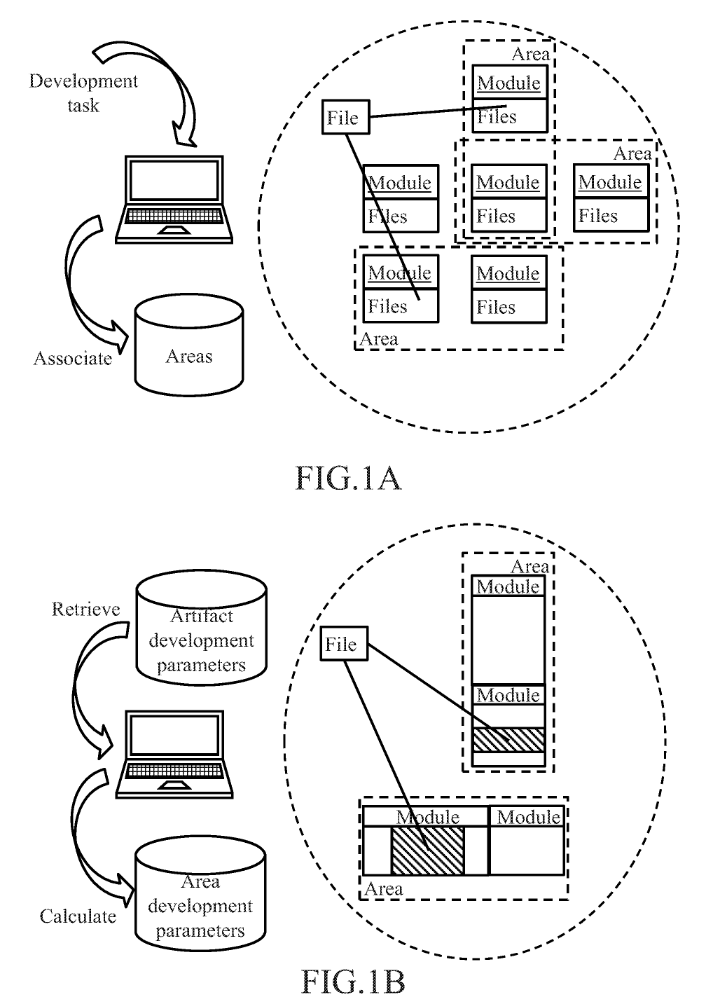

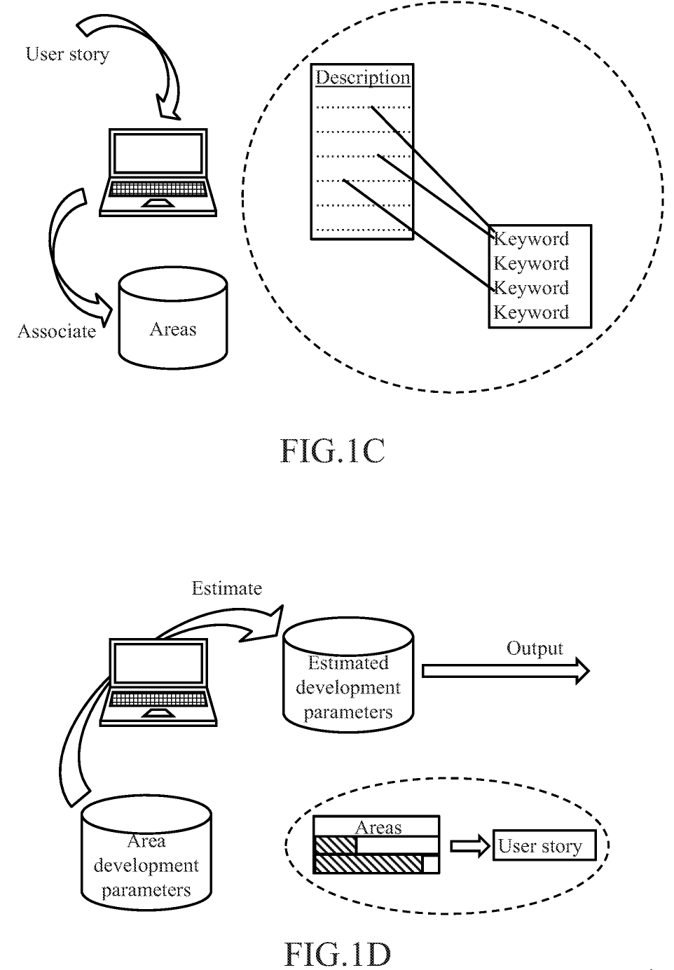

With reference in particular to FIG. 1A-FIG. 1D, the general principles are shown of the solution according to an embodiment of the present disclosure.

Starting from FIG. 1A, one or more development tasks have been completed during the development of a generic software program; for example, the development tasks relate to the implementation and the testing of software artifacts of the software programs (such as files thereof). In the solution according to an embodiment of the present disclosure, each file (of the development tasks) is associated with one or more functional areas, or simply areas, of the software program (such as relating to its security, backup); for example, the files may be aggregated into modules each associated with one or more areas.

Moving to FIG. 1B, one or more (artifact) development parameters of each file are retrieved; for example, the development parameters of the file comprise an implementation time and a test time thereof′. One or more (area) development parameters of each area are calculated according to the development parameters of the files associated therewith. For example, the development parameters of the area comprise the same implementation time and test time (such as calculated as a sum of the implementation times and the test times, respectively, of the files associated with the area, weighted according to their contribution to a whole size thereof).

Moving to FIG. 1C, a (new) functional specification of the software program to be developed is received (for example, a user story). The user story is associated with one or more (selected) functional areas of the software program; the association is performed according to a comparison of the user story with identification information of the functional areas (for example, by matching keywords of the functional areas with a description of the user story).

Moving to FIG. 1D, one or more (estimated) development parameters of the user story are estimated according to the development parameters of the areas associated therewith. For example, the development parameters of the user story comprise the same implementation time and test time (such as calculated as a sum of the implementation times and the test times, respectively, of the areas associated with the user story, weighted according to a confidence of their association therewith). An indication of the development parameters of the user story is then output for managing its development; for example, the implementation time and the test time of the user story may be used to schedule its implementation and a test thereof, respectively.

The above-described solution significantly improves the management of the software development.

Particularly, the development parameters that are estimated for each functional specification facilitate the planning of the corresponding development tasks of the software program; this operation may be automated (at least in part), so as to be less dependent on personal skills, less prone to errors and highly repeatable.

This solution allows predicting an impact of any change on the software program (based on corresponding historical/statistic information relating to its development). Particularly, the functional areas that should be affected by the change may be identified in advance. Moreover, it is possible to predict an effort required to implement and test the change, its defectiveness and an effort required to fix it; it is also possible to select the most appropriate tests for verifying the change and to evaluate a coverage thereof.

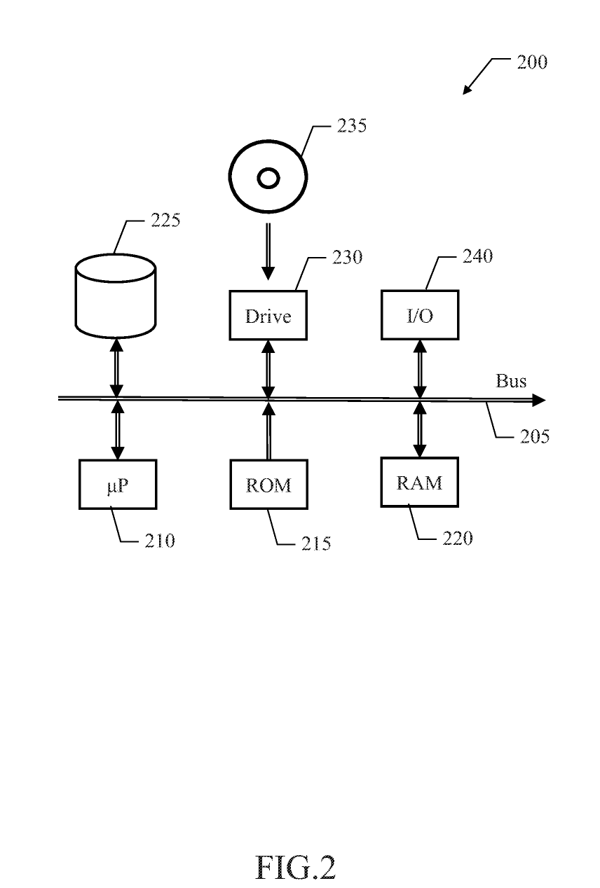

With reference now to FIG. 2, a schematic block diagram is shown of a computing system wherein the solution according to an embodiment of the present disclosure may be practiced.

The computing system 200, for example, a Personal Computer (PC), comprises several units that are connected among them through a bus structure 205 (with one or more levels). Particularly, one or more microprocessors (μP) 210 control operation of the computing system 200; a non-volatile memory (ROM) 215 stores basic code for a bootstrap of the computing system 200 and a volatile memory (RAM) 220 is used as a working memory by the microprocessors 210. The computing system 200 is provided with a mass-memory for storing programs and data; for example, the mass-memory comprises a hard-disk 225 and one or more drives 230 for reading/writing removable storage units 235 (such as optical disks, like DVDs). Moreover, the computing system 200 comprises several peripheral, or Input/Output (I/O), units 240; for example, the peripheral units 240 comprise a keyboard and a mouse for entering commands/information, a monitor for displaying information and a network adapter (NIC) for connecting to a communication network, for example, the Internet (not shown in the figure).

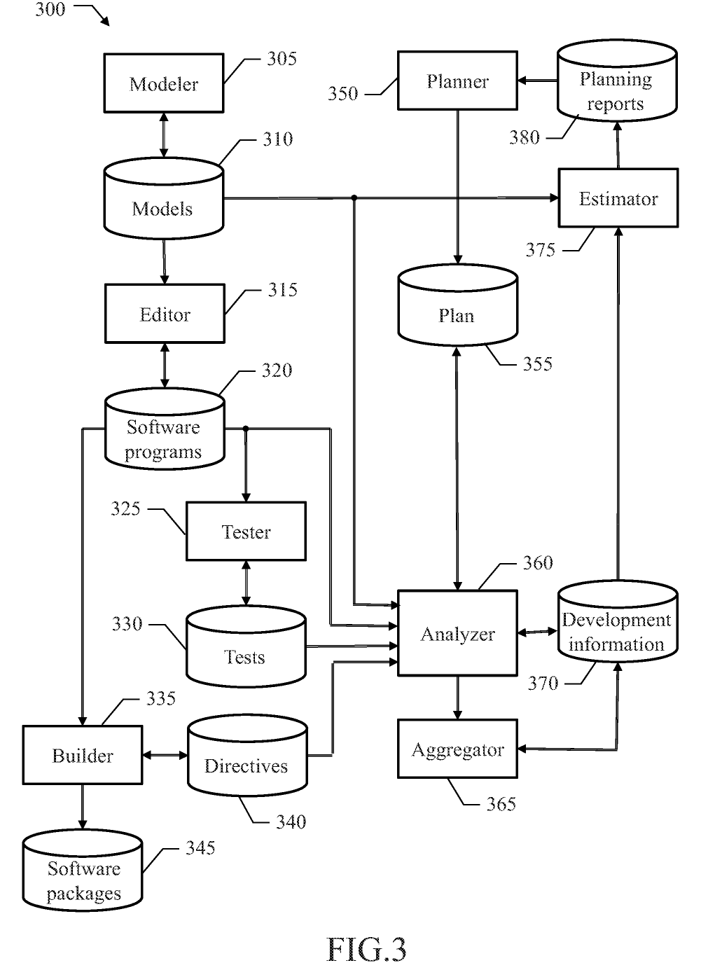

With reference now to FIG. 3, the main software components are shown that may be used to implement the solution according to an embodiment of the present disclosure.

All the software components (programs and data) are denoted as a whole with the reference 300. The software components are typically stored in the mass memory and loaded (at least partially) into the working memory of the computing system when the programs are running, together with an operating system and other application programs (not shown in the figure). The programs are initially installed into the mass memory, for example, from corresponding removable storage units or from the communication network. In this respect, each program may be a module, segment or portion of code, which comprises one or more executable instructions for implementing the specified logical function.

Particularly, the computing system runs an IDE that is used to develop software programs by one or more users thereof (for example, a development team). The IDE comprises the following components.

As far as relevant to the present disclosure, a modeler 305 is used to define functional requirements of each software program under development. The functional requirements describe what the software program does, independently of how the software program does it; for example, the functional requirements indicate input data, behavior and output data of the software program (such as in terms of interactions with corresponding end-users, connections to other software programs, performed operations). The functional requirements are defined by a (conceptual) model of the software program; the model is an abstraction of the software program, which provides a representation thereof being simplified but still conveying its fundamental principles (thereby allowing understanding, communicating and validating the software program before its actual implementation). For this purpose, the model comprises one or more functional specifications abstracting corresponding features of the software program. For example, the model may be defined according to the Agile software methodology in terms of user stories; each user story is a description in natural language of who performs what and why. The user stories may be grouped into user themes (collections of related user stories) and user epics (user stories defined at higher level). Alternatively, the model may be defined in terms of use cases; each use case describes an interaction with the software program to achieve a corresponding goal at high-level. For example, the use case may be defined by a use case diagram in the Unified Modelling Language (UML) with a sequence of steps that are performed by an actor to achieve the corresponding goal. The modeler 305 accesses (in read/write mode) a model repository 310, which stores the models of the software programs, for example, defined by their user stories (similar considerations apply to the use cases).

An editor 315 is used to write the software programs implementing the corresponding models. The editor 315 accesses (in read mode) the model repository 310 and it accesses (in read/write mode) a software program repository 320, which stores the software programs with corresponding information. Particularly, for each software program the software program repository 320 comprises the source code of the software program, organized in one or more software artifacts forming it that have already been developed (for example, files), an indication of any correlation among these files (for example, when a class of a file invokes one or more methods of a class of another file) and an indication of the user story that is implemented by each file; moreover, the software program repository 320 comprises some development parameters of each file, for example, an implementation time that has been required to implement it (i.e., write the corresponding code) and a (possible) fix time that has been required to fix any defects thereof. A tester 325 is used to test the software programs (to verify their correctness). The tester 325 accesses (in read mode) the software program repository 320. Moreover, the tester 325 accesses (in read/write mode) a test repository 330, which stores information relating to the tests of the software programs. For example, for each software program the test repository 330 comprises a test suite (defined by one or more test cases) for testing each user story that is implemented by the software program, a test time that has been required to run the test suite and an indication of any defects that have been discovered in the software program by the test suite. A builder 335 is used to build corresponding software packages of the software programs for their deployment into production (for example, based on the “Make” utility). The builder 335 accesses (in read mode) the software program repository 320. Moreover, the builder 335 accesses read/write mode)) a directive repository 340, which stores corresponding directives for building the software packages (for example, the “Makefile” of the “Make” utility); particularly, for each software program the directive indicates how to compile the files of the software program into one or more building blocks and how to link them. The builder 335 accesses (in write mode) a software package repository 345, which stores the software packages of the software programs. A planner 350 is used to plan the development tasks of the software programs (comprising implementation tasks for implementing the software programs and test tasks for testing the software programs). The planner 350 accesses (in read/write mode) a plan repository 355, which stores a corresponding development plan; the development plan defines a flow of the development tasks (for example, their scheduled timing) and tracks an execution thereof (for example, their actual duration, a list of the files that have been created/updated by each implementation task or a list of the test cases that have been run by each test task).

In the solution according to an embodiment of the present disclosure, an analyzer 360 is used to analyze the software programs to determine their development parameters. For each software program, the development parameters are determined at the level of one or more modules thereof; each module is any physical/logical entity that aggregates the files of the software program (for example, defined by its building blocks). The analyzer accesses (in read mode) the software program repository 320, the test repository 330, the directive repository 340 and the plan repository 355. Moreover, the analyzer 360 exploits an aggregator 365, which is used to aggregate the development parameters of the modules of the software programs at the level of their areas; each area represents an aspect of the software programs as defined by common features, functions or attributes (for example, relating to security, backup). Both the analyzer 360 and the aggregator 365 access (in read/write mode) a development repository 370, Which stores information for managing the development of the software programs as mentioned above. Particularly, the development repository 370 comprises corresponding definitions of the areas (for all the software programs); the definition of each area indicates a mnemonic description of the area and identification information that may be used to identify it (for example, one or more keywords). For each software program, the development repository 370 comprises corresponding module descriptors for the modules of the software program. The module descriptor of each module indicates the files that are comprised in the module and the test suites for verifying the module with their (test) coverage thereof; moreover, the module descriptor comprises the (module) development parameters of the module, for example, an (average) implementation time of the module, an (average) fix time for fixing any defects of the module, an (average) test time for testing the module and an (average) defect rate of the module. For each software program, the development repository 370 further comprises corresponding area descriptors for the areas of the software program. The area descriptor indicates the modules that are associated with the area and the test suites for testing the area with their (test) coverage thereof; moreover, the area descriptor comprises the development parameters of the area, for example, an (average) implementation time of the area, an (average) fix time for fixing any defects of the area, an (average) test time for testing the area and an (average) defect rate of the area.

An estimator 375 is used to estimate the development parameters of (new) user stories of the software programs to be developed. The estimator 375 accesses (in read mode) the model repository 310 and the development repository 370. Moreover, the estimator 375 accesses (in write mode) a planning report repository 380, which is also accessed (in read mode) by the planner 350. The planning report repository 380 stores planning reports of these user stories; the planning report of each user story comprises suggested test suites for testing an implementation of the user story with their (test) coverage thereof; moreover, the planning report comprises the development parameters of the user story, for example, an (estimated) implementation time of the user story, an (estimated) fix time for fixing any defects of the implementation of the user story, an (estimated) test time for testing the implementation of user story and an (estimated) defect rate of the implementation of the user story.

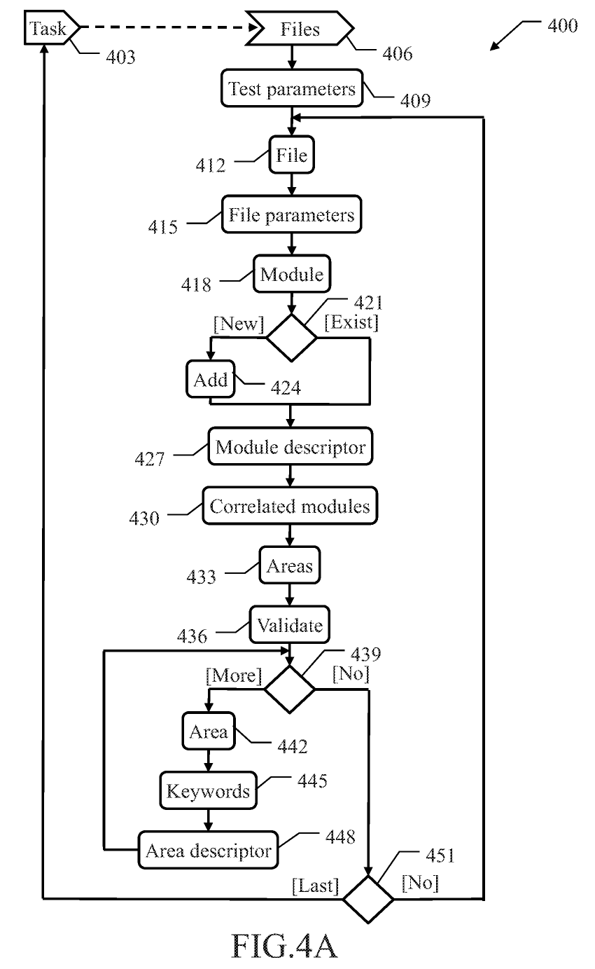

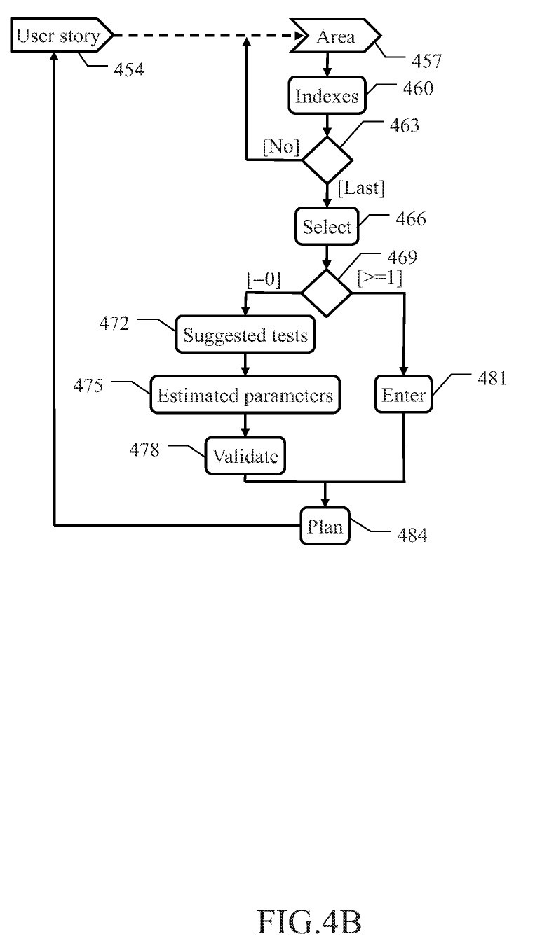

With reference now to FIG. 4A-FIG. 4B, an activity diagram is shown describing the flow of activities relating to an implementation of the solution according to an embodiment of the present disclosure.

Particularly, the diagram represents an exemplary process that may be used to manage the development of a generic software program with a method 400. In this respect, each block may correspond to one or more executable instructions for implementing the specified logical function on the computing system.

The process passes from block 403 to block 406 as soon as any development task for a corresponding (developed) user story has been completed, as indicated in the development plan (for example, detected by the analyzer that monitors it, such as every 1-10 minutes). In response thereto, the analyzer determines a list of the files relating to the development task. Particularly, in case of implementation task the list of the files that have been created/updated is retrieved (from the plan repository); in case of test task, instead, the user story that has been tested by the corresponding test suite is retrieved (from the plan repository) and then the files that implement this user story are retrieved (from the software program repository). Continuing to block 409, in case of test task the analyzer retrieves the development parameters corresponding to the test suite. Particularly, the analyzer retrieves the test time of the test suite, the number of defects that have been discovered by it and their fix times (from the test repository); the analyzer then calculates a defect rate of the test suite (for example, defined by a number of the defects that have been discovered by the test suite divided by a number of lines of the source code of the files implementing the corresponding user story, as indicated in the software program repository) and a fix time of the whole test suite (for example, equal to a sum of its fix times).

A loop is then entered for processing the files of the development task; the loop begins at block 412, wherein the analyzer takes a (current) one of these files into account (in any arbitrary order). Continuing to block 415, the analyzer retrieves the development parameters corresponding to the file. Particularly, in case of implementation task the analyzer retrieves the implementation time and the fix time of the file (from the software program repository). In case of test task, instead, the analyzer calculates a contribution of the file to the implementation of the user story of the test suite; for example, this contribution is defined by a (test) weight equal to a percentage of a size of the file with respect to the size of all the files implementing the user story (as indicated in the software program repository); the analyzer then calculates the test time of the file (for example, equal to the test time of the test suite multiplied by the weight of the file) and the defect rate of the file (for example, equal to the defect rate of the test suite).

The analyzer at block 418 determines the (current) module of the file; particularly, the module of the file is defined by the building block thereof (as indicated in the directive repository). A test is then made at block 421, wherein the analyzer verifies whether a module descriptor of the software program for this module exists in the development repository. If not, the analyzer at block 424 adds a corresponding new module descriptor to the development repository (initially empty). The process then descends into block 427; the same point is also reached directly from the block 421 if the module descriptor already exists. At this point, the analyzer updates the module descriptor accordingly in the development repository. Particularly, the analyzer calculates a contribution of the file to the module; for example, this contribution is defined by a (module) weight equal to a percentage of the size of the file with respect to the size of all the files of the module (as indicated in the software program repository). In case of implementation task, the analyzer adds the file to the module descriptor (if necessary). The analyzes then calculates the implementation time of the module as a running mean value of the implementation times of the files of the module multiplied by their weights, i.e., if the implementation time of the module is null the analyzer initializes it to the implementation time of the file, whereas otherwise the analyzer multiplies its previous value by a number of the files previously taken into account, adds the implementation time of the file multiplied by its weight and then divide this sum by the number of the files incremented by one; likewise, the analyzer calculates the fix time of the module as a running mean value of the fix times of the files of the module multiplied by their weights. In case of test task, instead, the analyzer adds an indication of the test suite with its test coverage (for example, equal to the weight of the file), The analyzer then calculates the test time and the defect rate of the module as a running mean value (as above) of the test times and the defect rates, respectively, of the files of the module multiplied by their weights.

Continuing to block 430, the aggregator looks for any (correlated) modules that are correlated to the (current) module, for example, the modules containing one or more files that are correlated thereto (as indicated in the software program repository). The aggregator at block 433 then looks for any areas associated with the module, i.e., the module is comprised in its area descriptor (as indicated in the development repository), The aggregator at block 436 prompts a user to validate the areas of the module. In this phase, the user may visualize a representation of the modules and the areas of the software program (for example, in a graphical form). The user may remove, change or add the areas of the module (with the corresponding area descriptors that are updated accordingly in the development repository); moreover, the user may also create new areas with their area descriptors into the development repository, by entering the corresponding mnemonic description and keywords for each one of them. A loop is then entered for processing the areas of the module (if any); the loop begins at block 439, wherein the aggregator verifies whether any areas of the module are still to be processed. If so, the aggregator at block 442 takes a (current) one of these areas into account (in any arbitrary order). Continuing to block 445, the aggregator updates the keywords of the area (if necessary). For example, the aggregator retrieves the user story relating to the file (as indicated in the software program repository) and the corresponding user epic, if any (from the model repository). The aggregator counts the occurrences of each keyword of the area in the user story and in the user epic. The aggregator then calculates a (keyword) relevance index of each keyword according to a weighted sum of its occurrences in the user story and in the user epic; for example, the occurrences of each keyword in the user story are multiplied by a corresponding (keyword) weight (set as described in the following) and the occurrences of each keyword in the user epic are multiplied by the corresponding weight reduced by an (epic) reduction factor (such as from 0.3 to 0.7, like 0.5). Moreover, the aggregator counts the occurrences of every significant term in the user story and in the user epic (for example, nouns, verbs and adjectives) and calculates a relevance index of each term as above (with a default value of the corresponding weight, such as 1). The aggregator displays the keywords and the terms having their relevance indexes (possibly strictly) higher than a threshold (for example, 30-50% of their maximum value) together with the corresponding relevance indexes (in decreasing order thereof); the aggregator then prompts the user to validate the keywords of the areas; in this phase, the user may change the weights of the keywords, may remove the keywords whose relevance indexes are too low and/or may add the terms with the highest relevance indexes as new keywords and may set the corresponding weights (with the definition of the area that is updated accordingly in the development repository). The aggregator at block 448 then updates the area descriptor accordingly in the development repository. Particularly, the aggregator adds the (current) module to the area descriptor (if necessary). The aggregator calculates a contribution of the current module and of each correlated module thereof (if any) to the area; for example, this contribution is defined by an (area) weight equal to a percentage of the size of the (current/correlated) module with respect to the size of all the modules of the area plus the correlated modules (as indicated in the software program repository); moreover, the weight of each correlated module is reduced by a (correlated) reduction factor (for example, from 0.3 to 0.7, such as 0.5). This allows taking into account an internal structure of the software program (as defined by the correlations of its files); however, the contributions of the correlated modules is reduced to account for the fact that they affect the area only indirectly. At this point, in case of implementation task the aggregator calculates the implementation time and the fix time of the area as a mean value of the implementation times and the fix times, respectively, of the (current/correlated) modules multiplied by their weights. In case of test task, instead, the aggregator adds an indication of the test suite with its test coverage (for example, equal to the weight of the current module). The analyzer then calculates the test, time and the defect rate of the area as a mean value of the test times and the fix times, respectively, of the (current/correlated) modules multiplied by their weights. The process then returns to the block 439 to verify again whether any areas of the module are still to be processed. As soon as no area of the module remains to be processed (always true when the module is not associated with any area), the above-described loop is exit by descending into block 451.

At this point, the analyzer verifies whether a last file of the implementation task has been processed. If not, the process returns to the block 412 to repeat the same operations for a next file of the development task. Conversely, once all the files of the development task have been processed, the flow of activity returns to the block 403 waiting for the completion of a next development task.

In a completely independent way, the process passes from block 454 to block 457 as soon as any (new) user story to be developed is created, as indicated in the model of the software program (for example, detected by the estimator that monitors it, such as every 1-10 minutes). In response thereto, a loop is entered for associating the user story with the areas of the software program. The loop begins by the estimator that takes a (current) one of the areas of the software program into account (in any arbitrary order). Continuing to block 460, the estimator counts the occurrences of each keyword of the area in the user story and in its user epic, if any (as indicated in the model repository). The estimator calculates an (area) relevance index of the area according to a weighted sum of the occurrences of the keywords in the user story and in the user epic as above (i.e., with the occurrences of each keyword in the user story that are multiplied by the corresponding weight and the occurrences of each keyword in the user epic that are multiplied by the corresponding weight reduced by the corresponding reduction factor); the value so obtained is then normalized (for example, to a range from 0 to 1 according to a predefined maximum value). The estimator at block 463 verifies Whether a last area of the software program has been processed. If not, the process returns to the block 457 to repeat the same operations for a next area of the software program. Conversely, once all the areas of the software program have been processed, the above-described loop is exit by descending into block 466. At this point, the estimator displays the mnemonic descriptions of the areas of the software program (extracted from the development repository) together with the corresponding relevance indexes (in decreasing order thereof); the areas having their relevance indexes higher than a threshold (for example, 0.5-0.7) are pre-selected for association with the user story. The estimator then prompts the user to validate the areas to be associated with the user story (with the user that may accept the pre-selected areas, may remove some of them or may add further ones).

The flow of activity now branches at block 469 according to a number of the (selected) areas that have been associated with the user story. If one or more areas have been associated with the user story, the estimator at block 472 determines (suggested) test suites of the user story as the union of the test suites of these areas. Moreover, the estimator calculates a (test) coverage of an implementation of the user story by each test suite thereof multiplying the test coverage of the area (by the same test suite) by the corresponding relevance index. The estimator than adds the test cases of the user story with their test coverages to a new planning report for it (in the planning report repository), Continuing to block 475, the estimator calculates the implementation time, the fix time, the test time and the defect rate of the user story as corresponding sums of the implementation times, the fix times, the test times and the defect rates of the selected areas multiplied by their relevance indexes. The estimator than adds the implementation time, the fix time, the test time and the defect rate of the user story to its planning report as well (in the planning report repository). Continuing to block 478, the estimator displays the planning report of the user story. The estimator then prompts the user to validate this planning report (with the user that may accept or update it). Referring back to the block 469, if no area has been associated with the user story, the estimator at block 481 prompts the user to enter the planning report of the user story manually.

The flow of activity merges again at block 484 from either the block 478 or the block 481. At this point, the planner updates the development plan (in the plan repository) according to the planning report of the user story (retrieved from the planning report repository). Particularly, the planner schedules one or more development tasks of the user story accordingly; for example, a development task for implementing the user story, a test task for testing the implementation of the user story and a further implementation task for fixing any defects of the implementation of the user story are scheduled according to the implementation time, the test time and the fix time, respectively, of the user story (whereas the defect rate of the user story is simply provided for information). The planner displays the (updated) development plan. The planner then prompts the user to validate the development plan (with the user that may accept or update it). The flow of activity then returns to the block 454 waiting for a next user story to be developed.

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. In any case, each numerical value should be read as modified by the term about (unless already done) and each range of numerical values should be intended as expressly specifying any possible number along the continuum within the range (comprising its end points). Moreover, ordinal or other qualifiers are merely used as labels to distinguish elements with the same name but do not by themselves connote any priority, precedence or order. The terms include, comprise, have, contain and involve (and any forms thereof) should be intended with an open, non-exhaustive meaning (i.e., not limited to the recited items), the terms based on, dependent on, according to, function of (and any forms thereof) should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for managing a development of a software program. However, the software program may be of any type (for example, an application, a middleware, an operating system) and its development may be of any type (for example, for creating, fixing, maintaining, evolving the software program).

In an embodiment, the method comprises receiving an indication of one or more development tasks of the software program that have been completed. However, the development tasks may be in any number and of any type (for example, implementation tasks, test tasks, stress tasks or any combination thereof) and their indication may be received in any way (for example, in push or pull mode from any source, entered manually).

In an embodiment, each of the development tasks relates to one or more software artifacts of the software program. However, the software artifacts may be in any number and of any type (for example, in addition or in alternative to the above-mentioned files, classes, routines, scripts, tables), and they may relate to the corresponding development tasks in any way (for example, because they are created, updated, tested, stressed or any combination thereof).

In an embodiment, the method comprises retrieving one or more development parameters of each of the software artifacts. However, the development parameters may be in any number and of any type (for example, in addition or in alternative to the above-mentioned implementation time, fix time, test time and defect rate, lines of new code, number of created/updated classes, either the same for all the software artifacts or specific for each type of them) and they may be retrieved in any way (for example, by reading directly, submitting queries, sending messages to any sources).

In an embodiment, the method comprises associating each of the software artifacts with one or more functional areas of the software program. However, the functional areas may be in any number and of any type (for example, in addition or alternative to the above-mentioned security and backup, database, authentication, virtualization); moreover, each software artifact may be associated with any number of functional areas (down to none) in any way (for example, directly or at the level of their modules, automatically, semi-automatically or manually).

In an embodiment, the method comprises calculating one or more development parameters of each of the functional areas. However, the development parameters of each functional area may be in any number and of any type (either the same or different with respect to the development parameters of the software artifacts).

In an embodiment, the development parameters of each functional area are calculated according to the development parameters of the software artifacts associated with the functional area. However, the development parameters of the functional area may be calculated in any way (for example, in addition or in alternative to weighting the development parameters of the software artifacts according to their contribution to the functional area as mentioned above, by increasing/decreasing the contribution of specific software artifacts according to their importance or even without any weighting).

In an embodiment, the method comprises receiving a functional specification of the software program to be developed. However, the functional specification may be of any time (for example, in addition or in alternative to the above-mentioned user story and use case, a user epic, a user theme, a statechart diagram, an activity diagram, a class diagram) and it may be received in any way (for example, in push or pull mode from any source, entered manually).

In an embodiment, the method comprises associating the functional specification with one or more selected functional areas (of said functional areas), according to a comparison of the functional specification with corresponding identification information of the functional areas. However, the functional specification may be associated (with any number of selected functional areas) according to any identification information of the functional areas (for example, in addition or in alternative to the above-mentioned keywords, by rules, queries); the association may be performed in any way (for example, in addition or in alternative to the matching of the keywords as mentioned above, by verifying rules, submitting queries).

In an embodiment, the method comprises estimating one or more development parameters of the functional specification. However, the development parameters of the functional specification may be in any number and of any type (either the same or different with respect to the development parameters of the functional areas).

In an embodiment, the development parameters of the functional specification are estimated according to the development parameters of the selected functional areas. However, the development parameters of the functional specification may be estimated in any way (for example, in addition or in alternative to weighting the development parameters of the selected functional areas according to the confidence of their association as mentioned above, by increasing/decreasing the contribution of specific functional areas according to their complexity or even without any weighting).

In an embodiment, the method comprises outputting an indication of the development parameters of the functional specification. However, the development parameters of the functional specification may be output in any way (for example, displaying, printing, passing to other software programs, such as the planner).

In an embodiment, the outputting of the development parameters of the functional specification is for managing a development thereof. However, this information may be used for any purpose (for example, in addition or in alternative to the above-mentioned planning of the development of the functional specification, for evaluating, budgeting, validating it) and in any way (for example, automatically, semi-automatically or manually).

In an embodiment, the method comprises planning the development of the functional specification according to the development parameters thereof. However, the development of the functional specification may be planned in any way (for example, for its implementation, test, fixing, deployment or any combination thereof), according to any number and type of the development parameters (for example, by adding a safety margin to the scheduled times, correcting them according to the defect rate of the functional specification).

In an embodiment, said step of calculating one or more development parameters of each of the functional areas comprises calculating the development parameters of each of the functional areas according to the development parameters of the software artifacts associated with the functional area weighted according to corresponding contributions thereof to the functional area. However, the contribution of the functional artifacts may be defined in any way (for example, a percentage of lines of source code, size of object code) and it may be used to weight the corresponding development parameters in any way (for example, linearly or non-linearly).

In an embodiment, the method comprises determining a corresponding module of one or more modules of the software program to which each of the software artifacts belongs. However, the modules may be in any number and of any type (for example, in addition or in alternative to the above-mentioned building blocks, files of classes/routines, folders of files, databases of tables); moreover, the module of each software artifact may be determined in any way (for example, in addition or in alternative to the above-mentioned use of the corresponding directive, by inspecting the software program, its model).

In an embodiment, the method comprises calculating one or more development parameters of each of the modules. However, the development parameters of each module may be in any number and of any type (either the same or different with respect to the development parameters of the software artifacts).

In an embodiment, the development parameters of each module are calculated according to the development parameters of the software artifacts belonging to the module, weighted according to corresponding contributions thereof to the module. However, the contribution of the software artifacts to the modules may be defined in any way (either the same or different with respect to their contribution to the functional areas) and it may be used to weight the corresponding development parameters in any way (as above); more generally, the development parameters of each module may be calculated in any way (with or without weighting the development parameters of the corresponding software artifacts as above).

In an embodiment, the method comprises associating each of the modules with one or more of the functional areas. However, each module may be associated with any number of functional areas (down to none) in any way (as above).

In an embodiment, the method comprises calculating the development parameters of each of the functional areas according to the development parameters of the modules associated with the functional area weighted according to corresponding contributions thereof to the functional area. However, the contribution of the modules to the functional areas may be defined in any way (either the same or different with respect to the contribution of the software artifacts to the modules) and it may be used to weight the corresponding development parameters in any way (as above); more generally, the development parameters of each functional area may be calculated in any way (with or without weighting the development parameters of the modules as above).

In an embodiment, the method comprises determining any correlated modules (of said modules) that is correlated to each of the modules. However, the correlated modules of each module may be in any number (down to none) and they may be determined in any way (for example, in addition or in alternative to the above-mentioned invocations of methods, according to inheritances of classes, implementations of interfaces, calls of routines).

In an embodiment, the method comprises calculating the development parameters of each of the functional areas according to the development parameters of the modules associated with the functional area and of the correlated modules thereof, weighted according to corresponding contributions thereof to the functional area (with the contributions of the correlated modules that are reduced with respect to the contributions of the modules associated with the functional area). However, the contributions of the correlated modules may be reduced in any way (for example, linearly or non-linearly), not at all or even completely (i.e., without taking them into account).

In an embodiment, said step of estimating one or more development parameters of the functional specification comprises estimating the development parameters of the functional specification according to the development parameters of the selected functional areas, weighted according to corresponding confidences of association of the functional specification with the selected functional areas. However, the confidence of association with each selected functional area may be defined in any way (for example, according to any confidence index based on occurrences of keywords, fulfillment of rules, result of queries in any way) and it may be used to weight the corresponding development parameters in any way (for example, linearly or non-linearly).

In an embodiment, the identification information of each of the functional areas comprises one or more keywords. However, the keywords may be in any number and of any type (for example, simple terms, combinations thereof).

In an embodiment, said step of associating the functional specification with one or more selected functional areas comprises associating the functional specification with the selected functional areas according to a matching of the functional specification with the keywords of the functional areas. However, the matching may be defined in any way (for example, in addition or in alternative to the above-mentioned confidence indexes of the functional areas, according to any other values, such as with or without weighting the keywords, taking into account the ancestor functional specification to any extent down to none at all, weighting the occurrences of the keywords differently according to their positions in the functional specifications, such as in a title, abstract or description, automatically, semi-automatically or manually).

In an embodiment, the method comprises associating the functional specification with the selected functional areas according to a comparison of the functional specification and of an ancestor functional specification of the functional specification with the identification information of the functional areas (with a contribution thereto of the ancestor functional specification that is reduced with respect to a contribution thereto of the functional specification). However, the contribution of the ancestor functional specification may be reduced in any way (for example, linearly or non-linearly), not at all or even completely (i.e., without taking it into account); more generally, it is possible to consider any other number and type of correlated functional specifications (for example, according to their uses, dependencies).

In an embodiment, the method comprises updating the identification information of each of the functional areas according to corresponding further functional specifications implemented by the software artifacts associated with the functional area. However, the identification information of each functional area may be updated according to each further functional specification in any way (for example, in addition or in alternative to the above-mentioned confidence indexes of the keywords of the functional area and of the terms of the functional specification, according to any other values as above, automatically, semi-automatically or manually).

In an embodiment, the development parameters comprise an indication of an implementation effort, of a fix effort, of a test effort and/or of a defectiveness. However, the (implementation/fix/test) effort and the defectiveness may be defined in any way (for example, in addition or in alternative to the above-mentioned time for the effort and defect rate for the defectiveness, according to man days, story points for the effort and according to defect number for the defectiveness).

In an embodiment, the method comprises determining the software artifacts being implemented by each of one or more implementation tasks of said development tasks and/or the software artifacts being tested by each of one or more test tasks of said development tasks. However, the software artifacts may be determined in any way (for example, when they are created, updated, fixed, tested, stressed or any combination thereof).

In an embodiment, the method comprises retrieving an indication of corresponding test suites that are run by the test tasks. However, the test suites may be of any type (for example, comprising any number and type of test cases, such has of functional or performance type) and they may be retrieved in any way (either the same or different with respect to the retrieval of the development parameters of the software artifacts).

In an embodiment, the method comprises assigning each of the test suites to the selected functional areas associated with each of the software artifacts that are tested by the test suite. However, each test suite may be associated with any number of selected functional areas (down to none) in any way (as above).

In an embodiment, the method comprises assigning the test suites of the selected functional areas to the functional specification. However, the test suites may be assigned in any way (for example, in alternative to the above-mentioned indiscriminate addition, by selecting them according to the impacted modules).

In an embodiment, the method comprises outputting an indication of the test suites of the functional specification. However, the test suites of the functional specification may be output in any way (for example, together or separately from the development parameters of the functional specification, in either the same or a different way).

In an embodiment, the outputting of the test suites of the functional specification is for managing a test of an implementation thereof. However, this information may be used for any purpose and in any way (for example, in addition or in alternative to the above-mentioned planning of the test of the implementation of the functional specification, for any other purpose as above).

In an embodiment, the method comprises calculating a test coverage of the selected functional areas by each of the test suites thereof. However, the test coverage may be defined in any way (for example, as a percentage of lines of source code, of size of object code).

In an embodiment, the test coverage is calculated according to a contribution of each of the software artifacts tested by the test suite to the functional area. However, the contribution of each software artifact to the functional area may be defined in any way (as above) and it may be used to determine the test coverage of the functional area in any way (for example, linearly or non-linearly); more generally, the test coverage of the functional area may be calculated in any other way (for example, with or without weighting the test coverage of the test suites, by increasing/decreasing the contribution of specific software artifact according to their importance).

In an embodiment, the method comprises calculating a test coverage of the selected functional specification by each of the test suites thereof according to the test coverages of the selected functional areas by the test suite weighted according to corresponding confidences of association of the functional specification with the selected functional areas. However, the confidence of association with each selected functional area may be defined in any way and it may be used to weight the corresponding test coverage in any way (either the same or different with respect to the estimation of the development parameters); more generally, the test coverage of the functional specification may be calculated in any other way (for example, with or without weighting the test coverage of the selected functional areas, by increasing/decreasing the contribution of specific functional areas according to their complexity).

In an embodiment, the method comprises outputting an indication of the corresponding test coverages in association with the test suites of the functional specification. However, the test coverages may be output in any way (for example, together or separately from the corresponding test suites, in either the same or a different way).

In an embodiment, the outputting of the test coverages is for managing the test of the implementation of the functional specification. However, this information may be used for any purpose (either the same or different with respect to the test suites of the functional specification).

Generally, similar considerations apply if the same solution is implemented with an equivalent method (by using similar steps with the same functions of more steps or portions thereof, removing some steps being non-essential, or adding further optional steps); moreover, the steps may be performed in a different order, concurrently or in an interleaved way (at least in part).

An embodiment provides a computer program configured for causing a computing system to perform the above-mentioned method when the computer program is executed on the computing system. An embodiment provides a computer program product, the computer program product comprising a computer readable storage medium having program instructions embodied therewith, the program instructions being executable by a computing system to cause the computing system to perform the same method. However, the computer program may be implemented as a stand-alone module, as a plug-in for a pre-existing computer program (for example, an IDE), or even directly in the latter; moreover, the computer program may run on any computing system (see below). In any case, the solution according to an embodiment of the present disclosure lends itself to be implemented even with a hardware structure (for example, by electronic circuits integrated in one or more chips of semiconductor material), or with a combination of software and hardware suitably programmed or otherwise configured.

An embodiment provides a system comprising means configured for performing each of the steps of the above-mentioned method. An embodiment provides a system comprising a circuitry (i.e., any hardware suitably configured, for example, by software) configured for performing each of the steps of the same method. However, the system may be of any type (for example, any physical and/or virtual computing machine, either stand-alone or communicating with other computing machines via any local, wide area, global, cellular or satellite network and exploiting any type of wired and/or wireless connections).

Generally, similar considerations apply if the system has a different structure or comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interactivity between different components generally does not need to be continuous, and it may be either direct or indirect through one or more intermediaries.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, in a data processing system, for managing a development of a software program, the method comprising:
receiving an indication of one or more development tasks of the software program being completed, each of the one or more development tasks relating to one or more software artifacts of the software program;
retrieving one or more development parameters of each of the one or more software artifacts;
associating each of the one or more software artifacts with one or more functional areas of the software program;
calculating one or more development parameters of each of the one or more functional areas according to the one or more development parameters of the software artifacts associated with the functional area;
receiving a functional specification of the software program to be developed;
associating the functional specification with one or more selected functional areas of the one or more functional areas according to a comparison of the functional specification with corresponding identification information of the one or more functional areas;
estimating one or more development parameters of the functional specification according to the one or more development parameters of the one or more selected functional areas; and
outputting an indication of the one or more development parameters of the functional specification for managing a development thereof.

2. The method of claim 1, further comprising:
planning the development of the functional specification according to the one or more development parameters thereof.

3. The method of claim 1, wherein calculating the one or more development parameters of each of the functional areas further comprises:
calculating the one or more development parameters of each of the one or more functional areas according to the one or more development parameters of the one or more software artifacts associated with the functional area weighted according to corresponding contributions thereof to the functional area.

4. The method of claim 1, further comprising:
determining a corresponding module of one or more modules of the software program to which each of the software artifacts belongs;
calculating one or more development parameters of each of the one or more modules according to the one or more development parameters of the one or more software artifacts belonging to the module weighted according to corresponding contributions thereof to the module;
associating each of the one or more modules with one or more of the functional areas; and
calculating the one or more development parameters of each of the one or more functional areas according to the one or more development parameters of the one or more modules associated with the functional area weighted according to corresponding contributions thereof to the functional area.

5. The method of claim 4, further comprising:
determining any correlated modules of the one or more modules being correlated to each of the one or more modules; and
calculating the one or more development parameters of each of the one or more functional areas according to the one or more development parameters of the one or more modules associated with the functional area and of the correlated modules thereof weighted according to corresponding contributions thereof to the functional area, the contributions of the correlated modules being reduced with respect to the contributions of the modules associated with the functional area.

6. The method of claim 1, wherein estimating the one or more development parameters of the functional specification further comprises:
estimating the one or more development parameters of the functional specification according to the one or more development parameters of the one or more selected functional areas weighted according to corresponding confidences of association of the functional specification with the selected functional areas.

7. The method of claim 1, wherein the identification information of each of the functional areas comprises one or more keywords and wherein associating the functional specification with one or more selected functional areas comprises:
associating the functional specification with the one or more selected functional areas according to a matching of the functional specification with the keywords of the one or more functional areas.

8. The method of claim 1, further comprising:
associating the functional specification with the one or more selected functional areas according to a comparison of the functional specification and of an ancestor functional specification of the functional specification with the identification information of the one or more functional areas, a contribution thereto of the ancestor functional specification being reduced with respect to a contribution thereto of the functional specification.

9. The method of claim 1, further comprising:
updating the identification information of each of the one or more functional areas according to corresponding further functional specifications implemented by the software artifacts associated with the functional area.

10. The method of claim 1, wherein the development parameters comprise an indication of an implementation effort, of a fix effort, of a test effort, or of a defectiveness.

11. The method of claim 1, further comprising:
determining the software artifacts being implemented by each of one or more implementation tasks of the one or more development tasks or the software artifacts being tested by each of one or more test tasks of the one or more development tasks.

12. The method of claim 11, further comprising:
retrieving an indication of corresponding test suites run by the one or more test tasks;
assigning each of the test suites to the one or more selected functional areas associated with each of the one or more software artifacts tested by the test suite;
assigning the test suites of the one or more selected functional areas to the functional specification; and
outputting an indication of the test suites of the functional specification for managing a test of an implementation thereof.

13. The method of claim 12, further comprising:
calculating a test coverage of each of the one or more selected functional areas by each of the test suites thereof according to a contribution of each of the one or more software artifacts tested by the test suite to the functional area;
calculating a test coverage of the selected functional specification by each of the test suites thereof according to the test coverages of the one or more selected functional areas by the test suite weighted according to corresponding confidences of association of the functional specification with the selected functional areas; and
outputting an indication of the corresponding test coverages in association with the test suites of the functional specification for managing the test of the implementation of the functional specification.

14. A computer program product comprising a computer readable storage medium having a computer readable program for managing a development of a software program stored therein, wherein the computer readable program, when executed on a computing device, causes the computing device to:
receive an indication of one or more development tasks of the software program being completed, each of the one or more development tasks relating to one or more software artifacts of the software program;
retrieve one or more development parameters of each of the one or more software artifacts;
associate each of the one or more software artifacts with one or more functional areas of the software program;
calculate one or more development parameters of each of the one or more functional areas according to the one or more development parameters of the software artifacts associated with the functional area;
receive a functional specification of the software program to be developed;
associate the functional specification with one or more selected functional areas of the one or more functional areas according to a comparison of the functional specification with corresponding identification information of the one or more functional areas;
estimate one or more development parameters of the functional specification according to the one or more development parameters of the one or more selected functional areas; and
output an indication of the One or more development parameters of the functional specification for managing a development thereof.

15. The computer program product of claim 14, wherein the computer readable program further causes the computing device to:
plan the development of the functional specification according to the one or more development parameters thereof.

16. The computer program product of claim 14, wherein the computer readable program to calculate the one or more development parameters of each of the functional areas further causes the computing device to:
calculate the one or more development parameters of each of the one or more functional areas according to the one or more development parameters of the one or more software artifacts associated with the functional area weighted according to corresponding contributions thereof to the functional area.

17. The computer program product of claim 14, wherein the computer readable program further causes the computing device to:
determine a corresponding module of one or more modules of the software program to which each of the software artifacts belongs;
calculate one or more development parameters of each of the one or more modules according to the one or more development parameters of the one or more software artifacts belonging to the module weighted according to corresponding contributions thereof to the module;
associate each of the one or more modules with one or more of the functional areas; and
calculate the one or more development parameters of each of the one or more functional areas according to the one or more development parameters of the one or more modules associated with the functional area weighted according to corresponding contributions thereof to the functional area.

18. The computer program product of claim 14, wherein the identification information of each of the functional areas comprises one or more keywords and wherein the computer readable program to associate the functional specification with one or more selected functional areas further causes the computing device to:
associate the functional specification with the one or more selected functional areas according to a matching of the functional specification with the keywords of the one or more functional areas.

19. The computer program product of claim 14, wherein the computer readable program further causes the computing device to:
associate the functional specification with the one or more selected functional areas according to a comparison of the functional specification and of an ancestor functional specification of the functional specification with the identification information of the one or more functional areas, a contribution thereto of the ancestor functional specification being reduced with respect to a contribution thereto of the functional specification.

20. An apparatus for managing a development of a software program comprising:
a processor; and
a memory coupled to the processor, wherein the memory comprises instructions which, when executed by the processor, cause the processor to:
receive an indication of one or more development tasks of the software program being completed, each of the one or more development tasks relating to one or more software artifacts of the software program;
retrieve one or more development parameters of each of the one or more software artifacts;
associate each of the one or more software artifacts with one or more functional areas of the software program;
calculate one or more development parameters of each of the one or more functional areas according to the one or more development parameters of the software artifacts associated with the functional area;
receive a functional specification of the software program to be developed;
associate the functional specification with one or more selected functional areas of the one or more functional areas according to a comparison of the functional specification with corresponding identification information of the one or more functional areas;
estimate one or more development parameters of the functional specification according to the one or more development parameters of the one or more selected functional areas; and
output an indication of the one or more development parameters of the functional specification for managing a development thereof.
